(19) United States
(12) Patent Application Publication
(10) Pub. No.: US 2006/0233276 A1
(43) Pub. Date: Oct. 19, 2006

(54) Spatial modulation in a wireless communications network

(76) Inventor: Marilynn P. Green, Pomona, NY (US)

Correspondence Address: MORGAN & FINNEGAN, LLP, 3 World Financial Center, New York, NY, 10281-2101, US

(21) Appl. No.: 11/107,651

(22) Filed: Apr. 18, 2005

(51) Int. Cl. H04L 1/02

(52) U.S. Cl. 375/267

(57) ABSTRACT

A signal (e.g., a UWB signal) is generated that conveys a first information sequence. This generation may employ various modulation techniques, such as OFDM and DSSS. To further convey a second information sequence, this signal is spatially modulated. Then, the signal may be transmitted to a remote device. Accordingly, this may involve emitting it from two or more spatial locations based on the second information sequence. In addition, an initialization process may be performed with the remote device to, for example, provide the remote device with a spatial frame of reference with respect to the spatially modulated signal. The first and second information sequences may both convey data. However, one or both of these sequences may convey various alternative or additional types of information. For example, the first information sequence may convey encrypted data, while the second information sequence provides information for decrypting this data

### FIELD OF THE INVENTION

The present invention relates to wireless communications. More particularly, the present invention relates to techniques that increase the utilization of bandwidth allocations in wireless communications networks.

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

A wireless personal area network (WPAN) referred to as IEEE 802.15.3a is currently under development. A high rate physical layer (PHY) standard is currently being selected for this network. One of the PHY candidates is based on frequency hopping application of orthogonal frequency division multiplexing (OFDM). This candidate is called Multiband OFDM (MB-OFDM). In order to further develop the OFDM proposal outside of the IEEE, a new alliance has been formed called the MultiBand OFDM Alliance (MBOA).

MB-OFDM utilizes OFDM modulation and frequency hopping. MB-OFDM frequency hopping may also involve the transmission of each of the OFDM symbols at various frequencies according to pre-defined codes, such as Time Frequency Codes (TFCs). This approach carves the available spectrum into multiple, non-overlapping frequency sub-bands over which OFDM symbols are sent. MB-OFDM currently specifies the use of 128 carriers within a 528 MHz band. Further, MB-OFDM also contemplates the hopping over an available communications bandwidth at 312.5 nanosecond intervals using different non-contiguous 528 MHz bands.

Bluetooth and wireless local area networks (WLAN) are examples of short-range wireless networking technologies. Bluetooth provides a short-range radio network, originally intended as a cable replacement. It can be used to create ad hoc networks of up to eight devices, where one device is referred to as a master device. The other devices are referred to as slave devices. The slave devices can communicate with the master device and with each other via the master device. The devices operate in the 2.4 GHz radio band reserved for general use by Industrial, Scientific, and Medical (ISM) applications. Bluetooth devices are designed to find other Bluetooth devices within their communications range and to discover what services they offer.

WLANs are local area networks that employ high-frequency radio waves rather than wires to exchange information between devices. IEEE 802.11 refers to a family of WLAN standards developed by the IEEE. In general, WLANs in the IEEE 802.11 family provide for 1 or 2 Mbps transmission in the 2.4 GHz band using either frequency hopping spread spectrum (FHSS) or direct sequence spread spectrum (DSSS) transmission techniques.

Within the IEEE 802.11 family are the IEEE 802.11b and IEEE 802.11g standards. IEEE 802.11b (also referred to as 802.11 High Rate or Wi-Fi) is an extension to IEEE 802.11 and provides for data rates of up to 11 Mbps in the 2.4 GHz band. This provides for wireless functionality that is comparable to Ethernet. IEEE 802.11b employs DSSS transmission techniques. IEEE 802.11g provides for data rates of up to 54 Mbps in the 2.4 GHz band. For transmitting data at rates above 20 Mbps, IEEE 802.11g employs Orthogonal Frequency Division Multiplexing (OFDM) transmission techniques. However, for transmitting information at rates below 20 Mbps, IEEE 802.11g employs DSSS transmission techniques. The DSSS transmission techniques of IEEE 802.11b and IEEE 802.11g involve signals that are contained within a 23 MHz wide channel. Several of these 23 MHz channels are within the ISM band.

Other technologies are also applicable for the exchange of information at higher data rates. Ultra wideband (UWB) is an example of such a higher data rate technology. Since gaining approval by the Federal Communications Commission (FCC) in 2002, UWB techniques have become an attractive solution for short-range wireless communications. Current FCC regulations permit UWB transmissions for communications purposes in the frequency band between 3.1 and 10.6 GHz. However, for such transmissions, the spectral density has to be under −41.3 dBm/MHz and the utilized bandwidth has to be higher than 500 MHz.

MB-OFDM is an example of UWB technology. However, there are many other UWB transmission techniques that are applicable for wireless communications. For instance, a common and practical UWB technique is called impulse radio (IR). In IR, data is transmitted by employing short baseband pulses that are separated in time by gaps. Thus, IR does not use a carrier signal. These gaps make IR much more immune to multipath propagation problems than conventional continuous wave radios. RF gating is a particular type of IR in which the impulse is a gated RF pulse. This gated pulse is a sine wave masked in the time domain with a certain pulse shape.

With wireless communications networks, such as the ones described above, there is a need to improve or increase the communications capacity of the allocated network bandwidth. Such improvements enhance user satisfaction by increasing throughput and reducing network latencies. In addition, from the network operator's perspective, such improvements may boost revenues by increasing the number of users and traffic the network can support.

### SUMMARY OF THE INVENTION

In embodiments of the present invention, a signal (such as a UWB signal) is generated that conveys a first information sequence. This generation may employ various modulation techniques, such as OFDM and DSSS. To further convey a second information sequence, this signal is spatially modulated. Then, the signal may be transmitted to a remote device. Accordingly, this may involve emitting it from two or more spatial locations based on the second information sequence.

In addition, an initialization process may be performed with the remote device to, for example, provide the remote device with a spatial frame of reference with respect to the spatially modulated signal. This initialization process may involve transmitting a predetermined spatially modulated symbol sequence to the remote device.

In further embodiments of the present invention, a wireless signal (such as a UWB signal) is received. From this signal, first and second information sequences are obtained through first and second demodulation techniques, respectively. The second technique is a spatial demodulation technique, while the first technique may be among various techniques, such as OFDM and DSSS. In addition, an initialization communication may be received from the remote device. This communication provides a spatial frame of reference with respect to the remote device.

An apparatus of the present invention includes first and second antennas at first and second locations, respectively. In addition, the apparatus includes first and second modulators. The first modulator generates a signal (e.g., through OFDM and/or DSSS techniques) that conveys a first information sequence, while the second modulator spatially modulates the signal to further convey a second information sequence. More particularly, the second modulator directs the signal to the first antenna when the second information sequence has a first value and directs the signal to the second antenna when the second information sequence has a second value.

A further apparatus of the present invention includes multiple antennas as well as first and second demodulators. The first demodulator obtains through spatial demodulation a first information sequence from multiple signals received from the antennas. In addition, the first demodulator generates a representative signal of the multiple signals. The second demodulator obtains a second information sequence from the representative signal through techniques such as OFDM and/or DSSS demodulation.

Moreover, the present invention provides computer program products that enable devices to perform the features of the present invention.

The aspects described above involve first and second information sequences. These sequences may both convey data. However, one or both of these sequences may convey various alternative or additional types of information. For example, the first information sequence may convey data that is encrypted, while the second information sequence provides information for decrypting the first information sequence.

The present invention provides advantages such as enhanced transmission capacity and/or security. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of a communications scenario;

FIGS. 2A and 2B are diagrams of a communications scenario involving spatial modulation according to embodiments of the present invention;

FIGS. 3 and 4 are flowcharts of exemplary device operation according to embodiments of the present invention;

FIG. 5 is a diagram of a device architecture according to an embodiment of the present invention;

FIG. 6 is a diagram of an exemplary transmitter according to an embodiment of the present invention;

FIG. 7 is a diagram of an exemplary receiver according to an embodiment of the present invention;

FIG. 8 is a diagram of a further device architecture according to an embodiment of the present invention;

FIG. 9 is a diagram of a exemplary wireless communications device implementation according to an embodiment of the present invention;

FIG. 10 is a diagram of an exemplary personal area network;

FIG. 11 is a diagram showing an exemplary MBOA superframe format;

FIG. 12 is a diagram of an available communications spectrum; and

FIG. 13 is a diagram illustrating a time frequency code.

### DETAILED DESCRIPTION OF THE PREFERRED EMBODIMENTS

### I. Communications Scenario

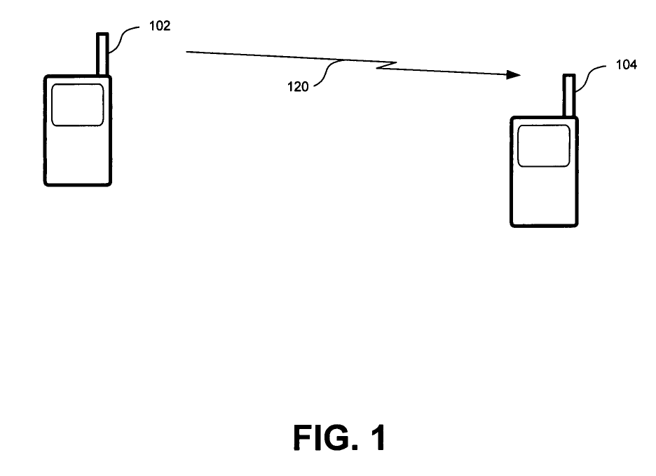

FIG. 1 is a diagram of a communications scenario in which a first wireless communications device 102 transmits a signal 120 to a second wireless communications device 104. Signal 120 conveys information to device 104 through the employment of one or more modulation techniques. As shown in FIG. 1, signal 120 emanates from a fixed area (e.g., from a single antenna) on device 102. Because of this, the employed modulation technique(s) involve varying the spectral, energy, and/or amplitude characteristics of signal 120. Examples of such modulation techniques include (but are not limited to) amplitude shift keying (ASK), frequency shift keying (FSK), phase shift keying (PSK), orthogonal frequency division multiplexing (OFDM), impulse radio (IR), direct sequence spread spectrum (DSSS), frequency hopping spread spectrum (FHSS), and code division multiple access (CDMA).

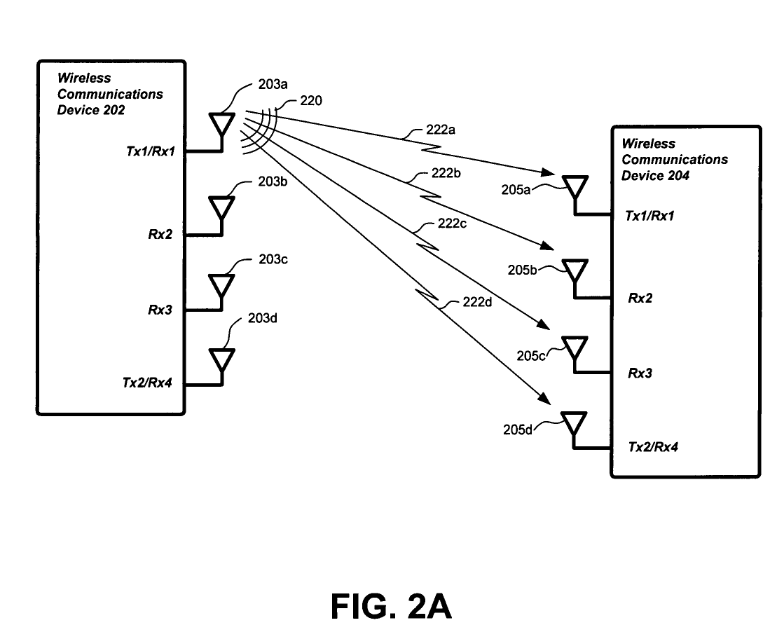

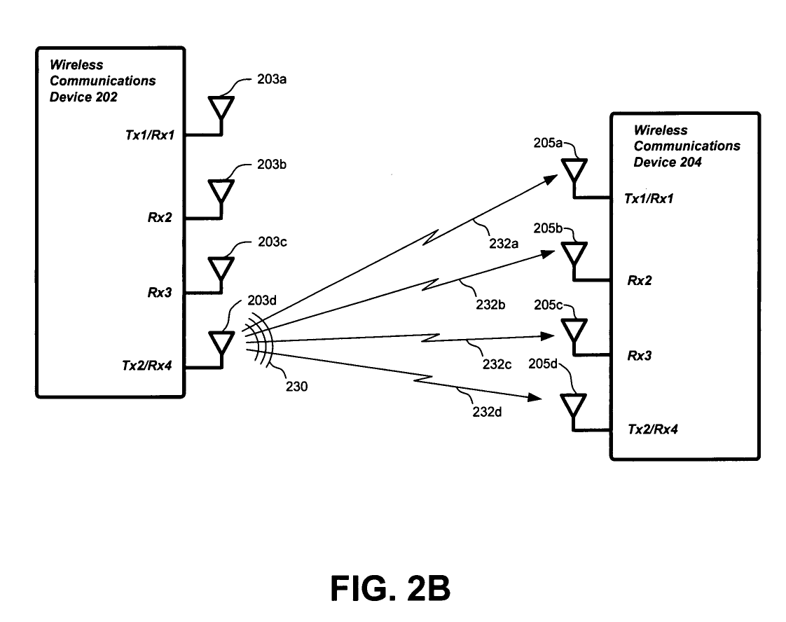

FIGS. 2A and 2B are diagrams of a communications scenario in which spatial modulation is employed to convey information from a first device 202 to a second device 204. As shown in these drawings, devices 202 and 204 each include multiple antennas. For instance, device 202 includes antennas 203a-d and device 204 includes antennas 205a-d. On these devices, these antennas are also individually labeled as either Tx1/Rx1, Rx2, Rx3, or Tx2/Rx4.

Having multiple antennas allows device 202 to vary the spatial areas or locations from which it emanates signals. Such spatial variations may be used to convey (or modulate) information. For devices 202 and 204, all of their antennas (i.e., Tx1/Rx1, Rx2, Rx3, and Tx2/Rx4) may be used to receive wireless signals. In contrast, only two of these antennas (Tx1/Rx1 and Tx2/Rx4) may be used for the transmission of wireless signals.

FIG. 2A shows the transmission of a binary “0” by device 202 according to an embodiment of the present invention. This transmission involves a signal 220 emanating from the antenna indicated as Tx1/Rx1. Signal 220 is received by device 204 along four separate transmission paths 222. In contrast, FIG. 2B shows the transmission of a binary “1” by device 202 according to an embodiment of the present invention. This transmission involves a signal 230 emanating from the antenna indicated as Tx2/Rx4. Signal 230 is received by device 204 along four separate transmission paths 232.

Device 204 is capable of discerning among the transmission paths employed by device 202. This discernment allows device 204 to decode spatially modulated signals into their corresponding symbols. For example, device 204 may decode signals 220 and 230 into a binary “0” and a binary “1”, respectively. In embodiments, such discernment involves calculating time differences in a signal's arrival at each of the multiple antennas.

### II. SPATIAL MODULATION OVERLAY

In embodiments of the present invention, wireless devices communicate using a modulation scheme, such as multiband OFDM (MB-OFDM) or direct sequence spread spectrum (DSSS). Such modulation schemes transmit symbols at predetermined intervals or time slots, each having a duration of T seconds. For instance, MBOA currently specifies T as 312.5 nanoseconds. This results in an OFDM symbol rate of 3.2 mega bits per second (Mbps).

A transmitting device may use each of these time slots to overlay the transmission of a spatially modulated symbol, such as a bit. Thus, in the case of binary spatial modulation, an additional bit rate of 1/T bits per second is achieved. For example, in the case of OFDM modulation employing a T of 312.5 nanoseconds, the corresponding additional bit rate is 3.2 Mbps.

A receiving device may determine which of multiple transmitting elements is being employed by the transmitting device based on its ability to localize the source of transmission. In the case of binary spatial modulation, this determination is then used to determine whether a “0” or a “1” has been transmitted. Exemplary source localization techniques are described below.

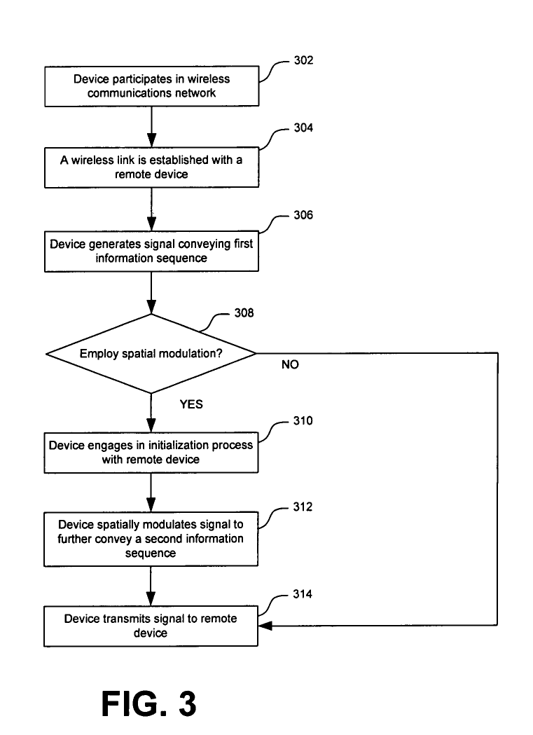

FIG. 3 is a flowchart of an operational sequence, according to embodiments of the present invention. In particular, this flowchart involves a device that transmits spatially modulated signals. The sequence of FIG. 3 includes a step 302. In this step, a device participates in a wireless communications network. This network may be a WPAN or other short-range wireless network.

In a step 304, a wireless link is established with a remote device.

Following this step, the device generates a signal in a step 306. This signal conveys a first information sequence. This signal is generated through the employment of a first (non-spatial) modulation technique. For example, this signal may be an OFDM signal, a DSSS signal, an impulse radio signal, or other type of signal. Moreover, in embodiments, this signal may further be a UWB signal.

As indicated by a step 308, the device determines whether to employ spatial modulation over the wireless link. If so, then a step 310 is performed. Otherwise, operation proceeds to a step 314. According to embodiments of the present invention, the determination whether to employ spatial modulation may include negotiation with a receiving device. This negotiation may involve the exchange of communication-related parameters. Examples of such parameters include, for example, an indication as to whether the receiving device supports spatial modulation techniques. Further, the determination whether to employ spatial modulation may include consulting the receiving device and/or transmitting device consulting active applications to avoid possible problem situations.

In a step 310, the device and the remote device engage in an initialization process. In this process, the device provides the remote device with a spatial frame of reference so that it may obtain identify particular spatially modulated symbols. This step may comprise the device sending one or more transmissions, such as a predetermined preamble sequence, to the remote device. Examples of such preamble sequences are described below.

In step 312, the device spatially modulates the signal to further convey a second information sequence. In embodiments, step 312 comprises designating the signal for transmission by one of a plurality of transmitting elements. Following step 312, operation proceeds to step 314.

As shown in FIG. 3, the device transmits the signal to the remote device in step 314. This step may include the device selectively transmitting the signal from two or more spatial locations (e.g., from two or more antennas) based on the second information sequence.

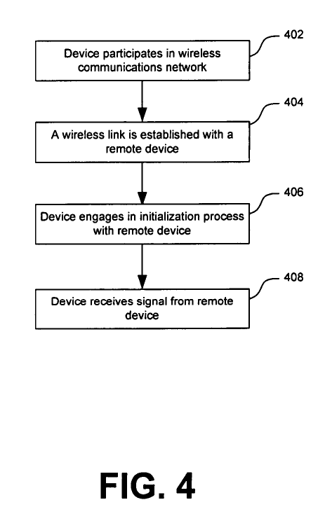

FIG. 4 is a flowchart of an operational sequence, according to embodiments of the present invention. In particular, this sequence involves a device that receives and demodulates signals that are spatially modulated. As shown in FIG. 3, this sequence includes a step 402. In this step, the device participates in a wireless communications network. This network may be a WPAN or other short-range wireless network.

In a step 404, a wireless link is established with a remote device.

In a step 406, the device engages in an initialization process with the remote device. This process involves the employment of spatial modulation over the wireless link. For instance, in embodiments, step 406 comprises the device obtaining a spatial frame of reference with respect to the remote device so that it may identify particular spatially modulated symbols. Accordingly, this step may comprise the device receiving one or more transmissions from the remote device. Such transmissions may include a predetermined preamble sequence. Examples of such preamble sequences are described below. According to embodiments of the present invention, the receiving device may already possess the spatial reference frame by maintaining a corresponding set of reference frames from prior connection(s) with the transmitting device.

As shown in FIG. 4, the device receives a signal from the remote device in a step 408. This signal conveys a first sequence of symbols from the remote device through the employment of a first (non-spatial) modulation technique. For example, this signal may be an OFDM signal, a DSSS signal, an impulse radio signal, or other type of signal. Moreover, in embodiments, this signal may further be a UWB signal. In addition, the signal received in step 408 conveys second sequence of spatially modulated symbols.

### III. Wireless Communications Device

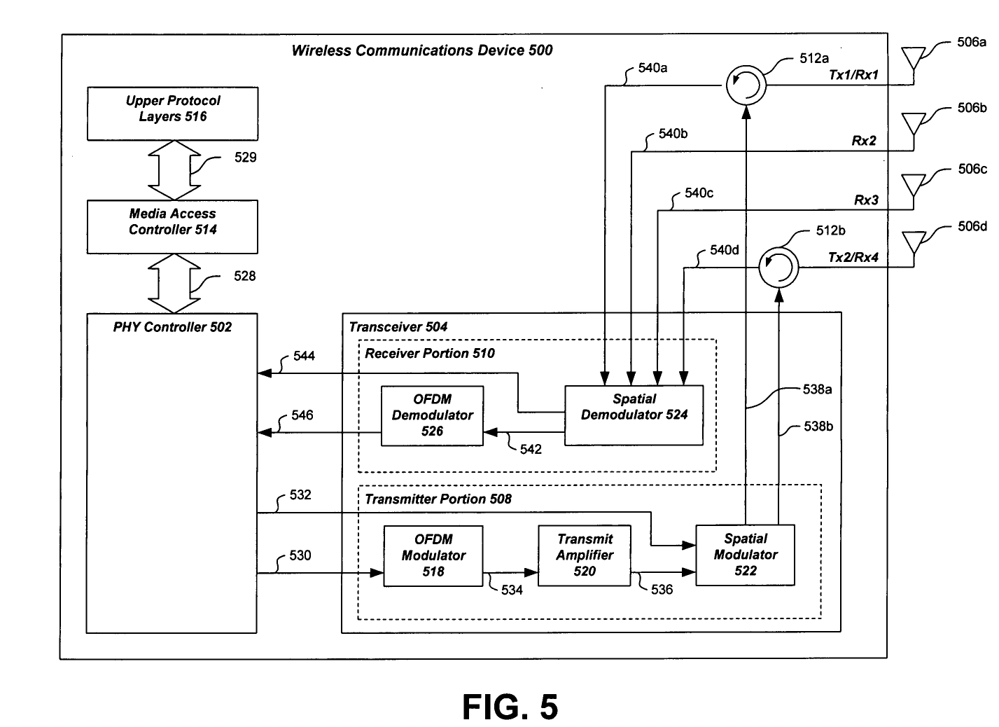

FIG. 5 is a diagram of a device architecture 500 that may communicate according to techniques of the present invention. For instance, this device architecture may employ spatial modulation overlay techniques, as described above.

As shown in FIG. 5, device architecture 500 includes a physical layer (PHY) controller 502, a transceiver 504, and a plurality of antennas 506. In addition, architecture 500 includes two circulators 512, a media access controller (MAC) 514, and upper protocol layers 516.

Transceiver 504 includes a transmitter portion 508 that receives symbol sequences 530 and 532 from PHY controller 502. From these sequences, transmitter portion 508 generates signals for wireless transmission via one or more of antennas 506a. In addition, transceiver 504 includes a receiver portion 510 that obtains symbol sequences 544 and 546 from wireless signals received via antennas 506. As shown in FIG. 5, receiver portion 510 delivers these symbol sequences to PHY controller 502.

FIG. 5 shows that transmitter portion 508 includes an OFDM modulator 518, a transmit amplifier 520, and a spatial modulator 522. OFDM modulator 518 receives symbol sequence 530 from PHY controller 502. From this sequence, OFDM modulator generates an OFDM signal 534 and sends it to transmit amplifier 520 for amplification.

This amplification produces an amplified OFDM signal 536, which is received by spatial modulator 522. In addition, spatial modulator 522 receives symbol sequence 532 from PHY controller 502. Spatial modulator 522 routes amplified OFDM signal 536 to one of antennas 506. This routing varies (or modulates) based on the values of symbols within sequence 532. Through this feature, the information of symbol sequence 532 is overlaid onto the OFDM modulated information of symbol sequence 530. This advantageously provides enhanced communications capacity without the use of additional spectral resources.

FIG. 5 shows that receiver portion 510 includes a spatial demodulator 524, and an OFDM demodulator 526. Spatial demodulator 524 receives multiple signals 540 from each of antennas 506. From these signals, spatial demodulator 524 derives an OFDM signal 542 and obtains symbol sequence 544. As shown in FIG. 5, OFDM signal 542 is sent to OFDM demodulator 526, while symbol sequence 544 is sent to PHY controller 502.

OFDM demodulator 526 demodulates OFDM signal 542. This demodulation yields symbol sequence 546, which is sent to PHY controller 502.

In embodiments, antennas 506a-d (also labeled as Tx1/Rx1, Rx2, Rx3, Tx2/Rx4) are positioned at distinct locations to provide for spatial modulation and demodulation.

Circulators 512a and 512b allow for both the transmission and reception of wireless signals through antennas 506a and 506d. In particular, circulators 512 pass signals received from antennas 506a and 506d to receiver portion 510, while passing signals received from transmitter portion 508 to these antennas.

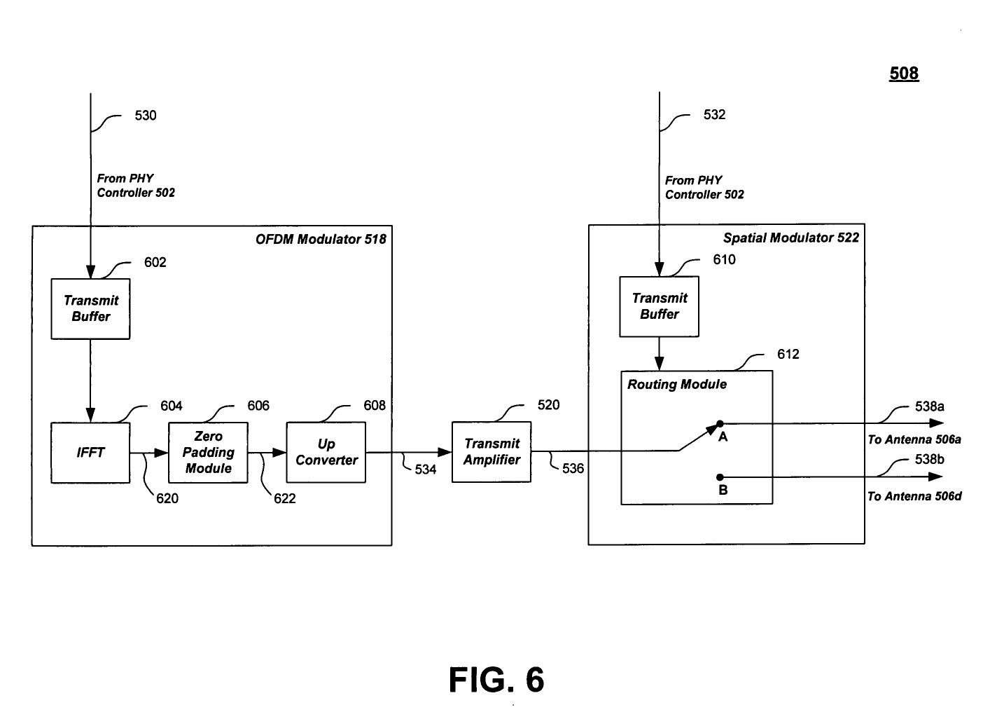

FIG. 6 is a diagram showing an exemplary implementation of transmitter portion 508 in greater detail, according to embodiments of the present invention. In this implementation, OFDM modulator 518 includes a transmit buffer 602, an inverse fast Fourier transform (IFFT) module 604, a zero padding module 606, and an upconverter 608. Transmit buffer 602 receives symbol sequence 530 from PHY controller 502 and stores them for eventual forwarding to IFFT module 604. This forwarding may be in response to a trigger, such as a transmit signal received from a timing controller (not shown).

In embodiments, symbol sequence 530 may be in the form of packets. In such embodiments, IFFT module 604 generates an OFDM modulated signal 620 from each packet that is received from transmit buffer 602. This generation involves performing one or more inverse fast Fourier transform operations. As a result, signal 620 includes one or more OFDM symbols. FIG. 6 shows that signal 620 is sent to zero padding module 606, which appends one or more “zero samples” to the beginning of each OFDM symbol in signal 620. This produces a padded modulated signal 622.

Upconverter 608 receives padded signal 622 and employs carrier-based techniques to place padded signal 622 into one or more frequency bands. These one or more frequency bands are determined according to a frequency hopping pattern, such as one or more time frequency codes (TFC), which are described in greater detail below. As a result, upconverter 608 produces OFDM signal 534, which is amplified by transmit amplifier 520 and sent to spatial modulator 522 as amplified OFDM signal 536.

FIG. 6 shows that spatial modulator 522 includes a transmit buffer 610 and a routing module 612. Transmit buffer 610 receives symbol sequence 532 from PHY controller 502. In turn, transmit buffer 610 stores symbols from this sequence and sends them to routing module 612 in a predetermined manner. In addition, FIG. 6 shows that routing module 612 receives amplified OFDM signal 536 from transmit amplifier 520.

Routing module 612 directs amplified OFDM signal 536 to a specific antenna based on the value of a current symbol received from transmit buffer 610. As shown in FIG. 6, routing module may include a switching element having a first output terminal (A) and a second output terminal (B). When the current symbol value from buffer 610 is a binary “0”, signal 536 is directed to output terminal A. However, when the current symbol value from buffer 610 is a binary “1”, signal 536 is directed to output terminal B.

As shown in FIG. 6, output terminal A sends signals to antenna 506a, while output terminal B sends signals to antenna 506d. Accordingly, antenna 506a is used for the transmission of binary “0” values in symbol sequence 532, while antenna 506d is used for the transmission of binary “1” values in symbol sequence 532.

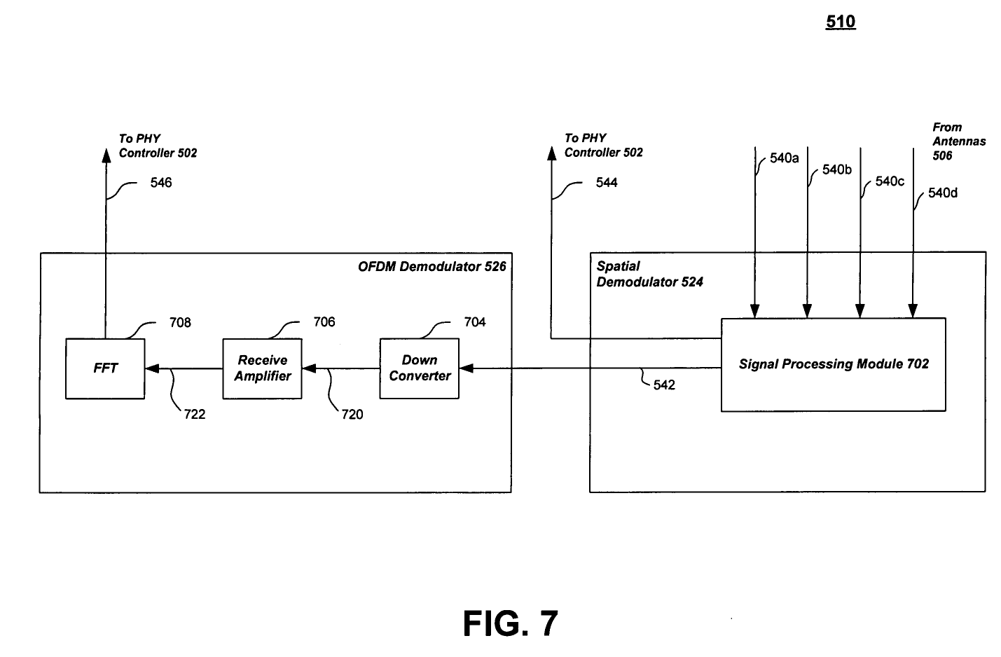

FIG. 7 is a diagram showing an exemplary implementation of receiver portion 510 in greater detail, according to an embodiment of the present invention. In this implementation, spatial demodulator 524 includes a signal processing module 702. Signal processing module 702 performs various operations to obtain spatially modulated symbols from received signals 540. In addition, signal processing module 702 produces OFDM signal 542 based on received signals 540. Production of signal 542 may be based on various techniques, such as selecting from received signals 540, or combining two or more of these received signals.

FIG. 7 shows OFDM demodulator 526 having a downconverter 704, a receive amplifier 706, and a fast Fourier transform (FFT) module 708. Downconverter 704 receives OFDM signal 542 from spatial demodulator 524. Upon receipt, downconverter 704 employs carrier-based techniques to convert OFDM signal 542 from its one or more frequency hopping bands (e.g., TFC bands) into a predetermined lower frequency range. This results in a downconverted OFDM signal 720, which is sent to receive amplifier 706. Amplifier 706 generates an amplified OFDM signal 722 from signal 720 and passes it to FFT module 708 for OFDM demodulation. This demodulation involves performing a fast Fourier transform for each symbol that is conveyed in signal 722.

As a result of this demodulation, FFT module 722 produces symbol sequence 546, which is sent to PHY controller 502. Like symbol sequence 530, sequence 546 may be in the form of one or more packets. These packets may convey various information, such as payload data and protocol header(s) for processing by PHY controller 502, MAC 514, and/or upper protocol layers 516.

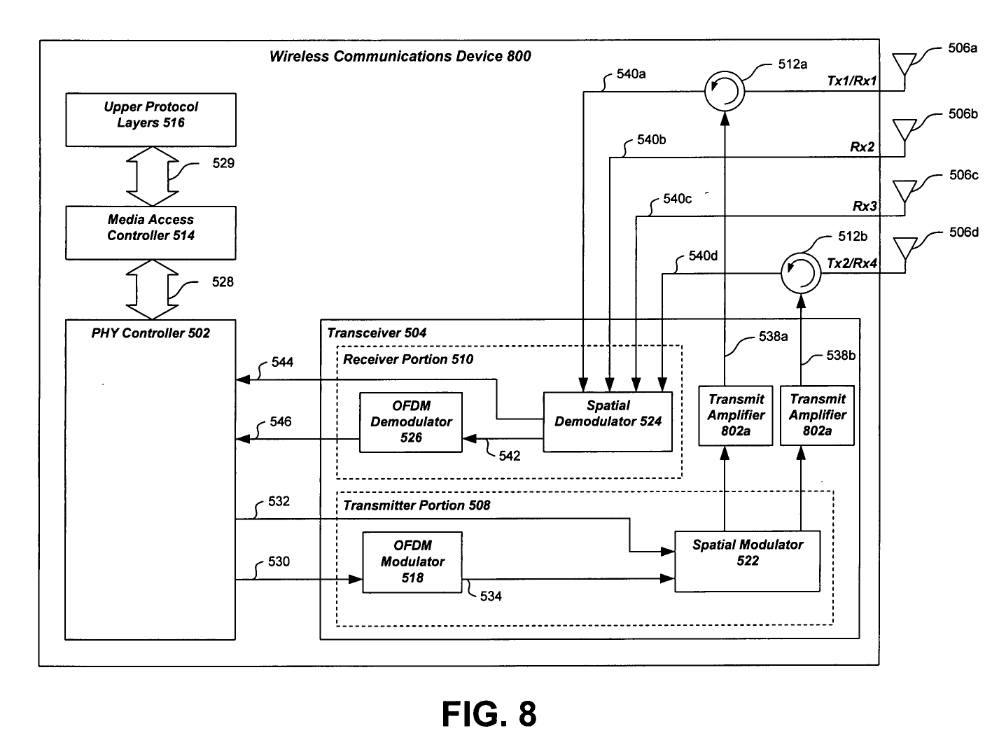

FIG. 8 is a diagram of a further device architecture 800 that may communicate according to techniques of the present invention. This architecture is similar to the architecture of FIG. 5. However, in the architecture of FIG. 8, transmit amplifier 536 is supplanted by transmit amplifiers 802a and 802b. Amplifiers 802 are placed after spatial modulator 522. According to this architecture, the transmitter portion of FIG. 6 may be modified to exclude transmit amplifier 520.

The devices of FIGS. 5 and 8 may be implemented in hardware, software, firmware, or any combination thereof. For instance, transceiver 504 and circulators 512 may include electronics, such as amplifiers, mixers, and filters. Moreover, implementations of these devices may include digital signal processor(s) (DSPs) to implement various modules, such as modulators 518 and 522, as well as demodulators 524 and 526. Moreover, in embodiments of the present invention, processor(s) (e.g., microprocessors) executing instructions, such as software, that are stored in memory may be used to control the operation of various components in these devices. For instance, components, such as PHY controller 502, MAC 514, and upper protocol layers 516 may be primarily implemented through software operating on one or more processors.

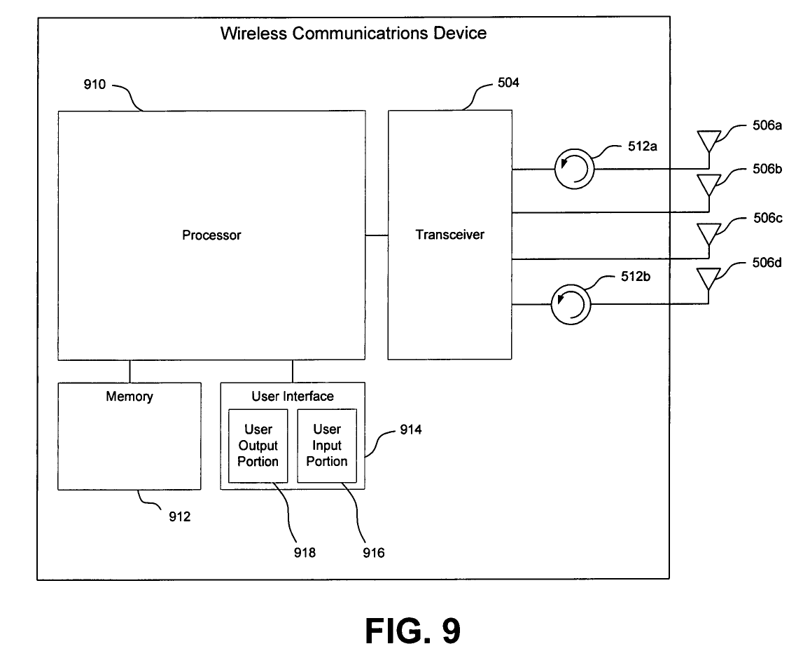

One such device implementation according to an embodiment of the present invention is shown in FIG. 9. As shown in this drawing, the implementation includes a processor 910, a memory 912, and a user interface 914. In addition, the implementation of FIG. 9 includes OFDM transceiver 804 and antenna 810. These components may be implemented as described above with reference to FIGS. 8-10. However, the implementation of FIG. 9 may be modified to include different transceivers that support other wireless technologies. Also, it is apparent that the features of FIG. 9 may be modified to implement devices of FIGS. 5 and 8.

Processor 910 controls device operation. As shown in FIG. 9, processor 910 is coupled to transceiver 504. Processor 910 may be implemented with one or more microprocessors that are each capable of executing software instructions stored in memory 912, for example, as a computer system.

Memory 912 includes random access memory (RAM), read only memory (ROM), and/or flash memory, and stores information in the form of data and software components (also referred to herein as modules). These software components include instructions that can be executed by processor 910. Various types of software components may be stored in memory 912. For instance, memory 912 may store software components that control the operation of transceiver 804. Also, memory 912 may store software components that provide for the functionality of PHY controller 502, MAC 514, and upper protocol layer(s) 516.

In addition, memory 912 may store software components that control the exchange of information through user interface 914. As shown in FIG. 9, user interface 914 is also coupled to processor 910. User interface 914 facilitates the exchange of information with a user. FIG. 9 shows that user interface 914 includes a user input portion 916 and a user output portion 918.

User input portion 916 may include one or more devices that allow a user to input information. Examples of such devices include keypads, touch screens, and microphones. User output portion 918 allows a user to receive information from the device. Thus, user output portion 918 may include various devices, such as a display, and one or more audio speakers (e.g., stereo speakers) and a audio processor and/or amplifier to drive the speakers. Exemplary displays include color liquid crystal displays (LCDs), and color video displays.

The elements shown in FIG. 9 may be coupled according to various techniques. One such technique involves coupling transceiver 504, processor 910, memory 912, and user interface 914 through one or more bus interfaces. In addition, each of these components is coupled to a power source, such as a removable and/or rechargeable battery pack (not shown).

### IV. Spatial Demodulation

As described above, embodiments of the present invention employ spatial modulation in the transmission of signals. Such modulation may be used to overlay an additional stream of information onto a signal that is carrying information modulated according to other non-spatial technique(s). Upon receipt of spatially modulated signals, a device may employ various techniques to obtain the spatially modulated information. Such techniques are referred to herein as source localization and involve discerning the orientation of the transmitted signal.

For instance, a receiving device having multiple receiving elements (e.g., two or more elements arranged in a receiving array) may measure a received waveform signal at two or more of its receiving elements. From these measurements, a time difference of arrival between two or more of the received waveforms may be obtained.

An exemplary embodiment involves a receiving device having a linear array of N (N≧2) receiving elements spaced at equidistant intervals. These elements may be arranged to satisfy various spatial sampling requirements. To localize the source of transmission, the receiving device may measure the time delay in signal reception at different receiving elements. For example, the receiving device may measure such a relative time delay between a reference receiving element and another receiving element. This other element is referred to herein as the m-th element because it is an integer m elements away from the reference element. When a particular transmitting element at the transmitting device (referred to as the n-th transmitting element) is active, this relative time delay is quantitatively represented for near field propagation situations as:

$${τ}_{m}^{near} = \frac{r - \sqrt{{r}^{2} - 2 ( m - 1 ) r d sin {θ}_{n} + {( m + 1 )}^{2} {d}^{2}}}{c}$$

In the above expression, c denotes the speed of light, d denotes the inter-sensor spacing, m is the element index, r represents the range, (distance) of the near-field transmitter. τₘ is the time delay between the reference and the m-th antenna element, and θₙ is the direction of arrival.

However, when r>>d, then the transmitting device is in the far-field of the receiving device's array of receiving elements. In such far field propagation situations, the relative time delay at the receiving device's reference element and m-th element is expressed as:

$${τ}_{m}^{far} = ( m - 1 ) \frac{d sin {θ}_{n}}{c}$$

Accordingly, in embodiments of the present invention, a receiving device may employ the above expressions to determine θₙ. From this determination, the receiving device may ascertain the spatially modulated symbol corresponding to the received transmission. Such determinations may be performed through real time calculations, look-up tables, and/or other suitable techniques.

Although this example involves an array of linearly arranged receiving elements, the present invention may be employed with any array geometry of transmitting and receiving elements. Moreover, numerous alternative algorithms may be used by the receiver to perform source localization. For instance, in the near-field case, algorithms may be used to estimate the transmitting device's coordinates (r, θₙ). Also, in the far-field case, algorithms may be used to estimate the transmitting device's direction of arrival, θₙ. Examples of such algorithms include (but are not limited to) linear prediction, maximum likelihood estimation, multiple signal classification (MUSIC), and estimation of signal parameters via rotational invariance technique (ESPRIT).

### V. Initialization

As described above with reference to FIGS. 3 and 4, a transmitting device and a receiving device perform an initialization process. For instance, in steps 310 and 406, initialization transmissions are communicated to provide the receiving device with a frame of reference for the spatial modulation performed by the transmitting device. Based on this frame of reference, the receiving device may distinguish between distinct symbol values.

In embodiments of the present invention, the two devices employ a protocol that involves the transmitting device sending a preamble. This preamble includes a predetermined spatially modulated information sequence. An example of such a preamble is a spatially modulated “0” followed by a spatially modulated “1”. However, other preambles and other preamble lengths may be employed.

Upon receipt of the preamble, the receiving device estimates the transmitting device's position (or angles of arrival) that is associated with each of the preamble's symbols. After this initialization procedure, the devices may begin to transfer spatially modulated code words.

In further embodiments of the present invention, other initialization preambles and/or initialization techniques may be employed. For instance, a Barker sequence may be used as an initialization preamble.

One implementation for this invention is with the MB-OFDM modulation method, which is being proposed by the MBOA (Multiband OFDM Alliance) Group for use in IEEE 802.15.3a Wireless Personal Area Networks (WPANs).

This invention increases the data rate of the existing MB-OFDM signal by using two transmitters instead of one. During the switching time, which the MB-OFDM transmitter would normally be used to change the band over which it will communicate during the next time slot (the red hatched area in FIG. 1), it can also use this time in order to switch between different transmitters when the next spatially modulated bit differs from the current one.

### VI. Personal Area Networks

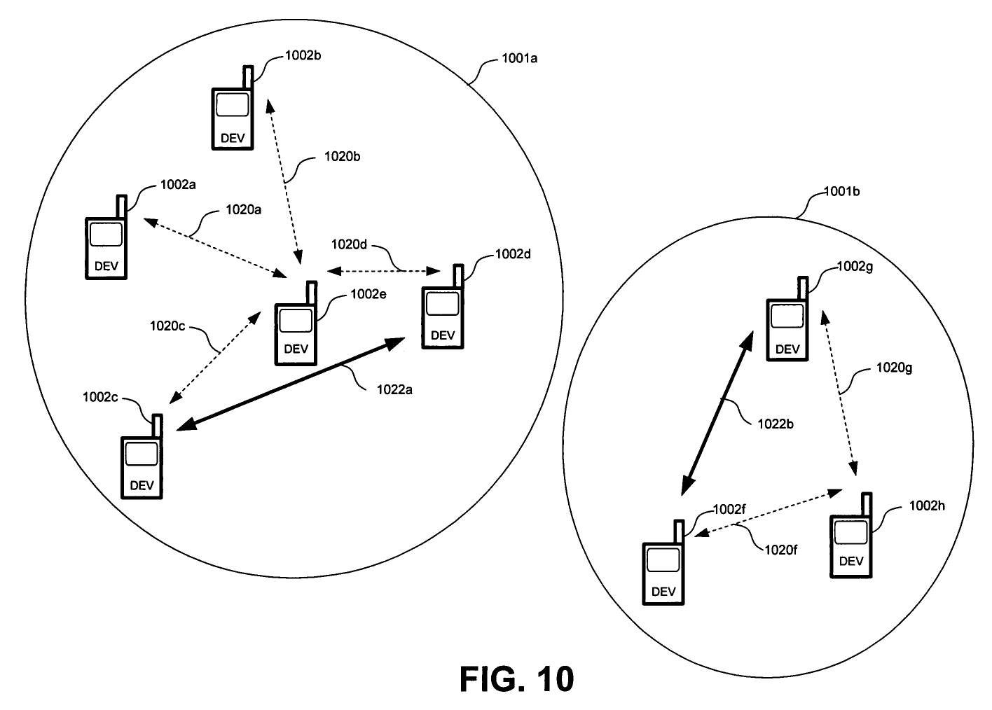

The techniques of the present invention may be employed in various types of networks. One such network is a wireless personal area network (WPAN). FIG. 10 is a diagram of an exemplary WPAN, which includes a plurality of devices (DEVs) 1002. These devices are arranged into multiple groups 1001. For instance, FIG. 10 shows a group 1001a and a group 1001b. Group 1001a includes DEVs 1002a-e, while group 1001b includes DEVs 1002f-1002h.

In group 1001a, each of DEVs 1002a-d may communicate with DEV 1002e across a corresponding link 1020. For instance, FIG. 10 shows DEV 1002a communicating with DEV 1002e across a link 1020a. In addition, in group 1001a, each of devices 1002a-e may communicate with each other directly. For instance, FIG. 10 shows DEVs 1002c and 1002d communicating via a direct link 1022a.

In group 1001b, each of DEVs 1002f and 1002g may communicate with DEV 1002h across a corresponding link 1020. For instance, DEV 1002f communicates with DEV 1002h across a link 1020f, while DEV 1002g communicates with DEV 1002h across a link 1020g. DEVs 1002f and 1002g in group 1001b may also communicate with each other. For example, FIG. 10 shows DEVs 1002f and 1002g communicating across a link 1022b.

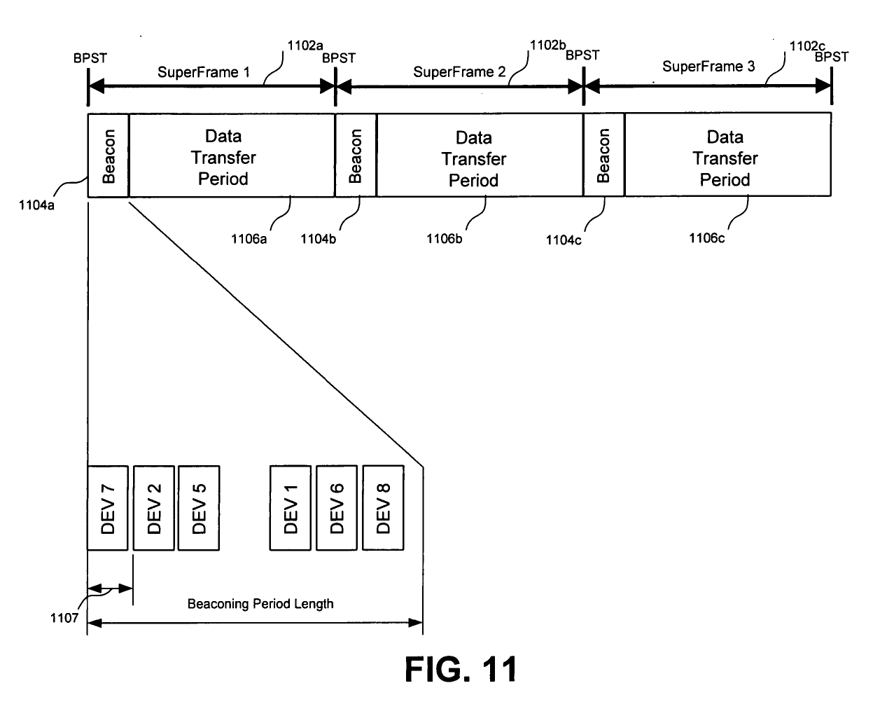

Transmissions of groups 1001a and 1001b may each be based on a repeating time interval. In the context of MBOA, this repeating time interval is called a superframe. Accordingly, FIG. 10 is a diagram showing an exemplary MBOA superframe format. In particular, FIG. 11 shows a frame format having superframes 1102a, 1102b, and 1102c. As shown in FIG. 11, superframe 1102b immediately follows superframe 1102a, and superframe 1102c immediately follows superframe 1102b.

As shown in FIG. 11, each superframe 1102 includes a beacon period 1104 and a data transfer period 1106. Beacon periods 1104 convey transmissions from each of the active devices in the beaconing group. Accordingly, each beacon period 1104 includes multiple beacon slots 1107. Slots 1107 each correspond to a particular device in the beaconing group. During these slots, the corresponding device may transmit various overhead or networking information.

For instance, such information may be used to set resource allocations and to communicate management information for the beaconing group. In addition, according to the present invention, data transfer periods 1106 may be used to transmit information regarding services and features (e.g., information services, applications, games, topologies, rates, security features, etc.) of devices within the beaconing group. The transmission of such information in beacon periods 1104 may be in response to requests from devices, such as scanning devices.

Data transfer periods 1106 are used for devices to communicate data according to, for example, frequency hopping techniques that employ OFDM and/or TFCs. For instance, data transfer periods 1106 may support data communications across links 1020 and 1022. In addition, devices (e.g., DEVs 1002a-e) may use data transfer periods 1106 to transmit control information, such as request messages to other devices. To facilitate the transmission of traffic, each DEV may be assigned a particular time slot within each data transfer period 1106. In the context of the MBOA, these time slots are referred to as media access slots (MASs).

A MAS is a period of time within data transfer period 206 in which two or more devices are protected from contention access by devices acknowledging the reservation. MASs may be allocated by a distributed protocol, such as the distributed reservation protocol (DRP). Alternatively, resources may be allocated by the prioritized contention access (PCA) protocol. Unlike DRP, PCA isn't constrained to reserving one or more entire MASs. Instead, PCA can be used to allocate any part of the superframe that is not reserved for beaconing or DRP reservations.

Each of links 1022 and 1020 may employ various frequency hopping patterns. For instance, in embodiments of the present invention that employ MBOA communications, each group 1001 uses a particular frequency hopping pattern. These patterns may either be the same or different. Examples of such patterns include, for example, one or more Time Frequency Codes (TFCs).

Such TFCs dictate a sequence in which to employ a plurality of frequency hopping channels for the transmission of successive symbols (such as OFDM symbols). For example, an exemplary scheme involves the transmission of each of a plurality of OFDM symbols at one of three frequencies according to pre-defined code.

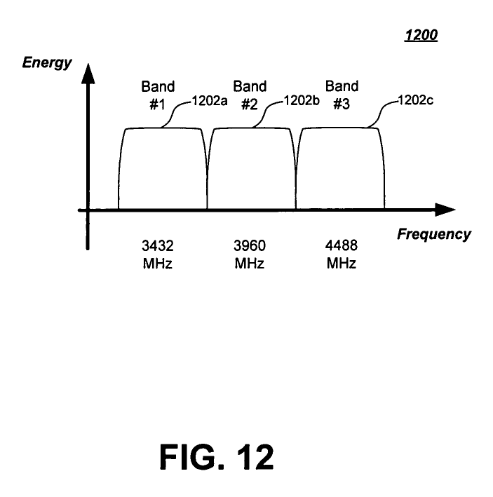

FIG. 12 is a diagram of an available spectrum 1200 for a short-range communications system in which the principles of the present invention may be applied, such as in an MBOA network. As shown in FIG. 12, this spectrum includes three frequency channels 1202. In particular, spectrum 1200 includes a first channel 1202a, a second channel 1202b, and a third channel 1202c. These channels may each be centered at various frequencies suitable for the transmission of OFDM symbols.

According to MBOA, channels 1202 may be used as hopping channels. When used in this manner, each symbol (e.g., each OFDM symbol) is transmitted in one of channels 1202 according to a pre-defined code (i.e., a TFC). This technique provides for frequency diversity, as well as robustness against multi-path propagation and interference. In addition, this technique allows for multiple-access by utilizing different TFCs for adjacent groups of devices.

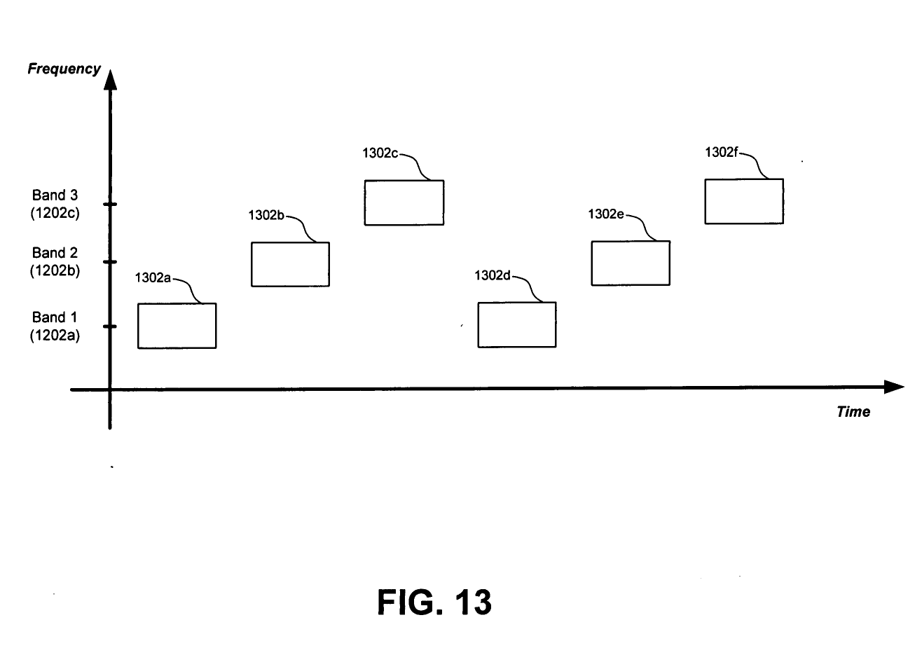

FIG. 13 is a diagram showing an example of this frequency-hopping technique. In particular, FIG. 13 shows signal transmission according to a particular TFC. In this TFC, symbols 1302 are transmitted at frequencies according to the repeating sequence of first channel 1202a, followed by second channel 1202b, followed by third channel 1202c.

### VII. Encryption/Security Features

Embodiments of the present invention employ spatial modulation techniques, such as the ones described herein, to transmit security and/or encryption information. This information may correspond to corresponding payload data that is transmitted according to the underlying non-spatial modulation technique(s). For instance, this overlaid information may be necessary to decrypt the underlying payload data. Accordingly, this information may include a decryption key and/or a hash the key.

This technique provides enhanced security because it is very hard for an eavesdropper to intercept information provided through spatial modulation. This is especially true when the transmitting and receiving devices have negotiated the spatial modulation characteristics/rules beforehand. Also, in embodiments of the present invention, this security and/or encryption information may be substantially short so that it can be transmitted sequentially. This ensures that the receiving device will receive the code correctly.

In further embodiments of the present invention, spatial modulation may be used to transmit both security/encryption information as well as additional data. Moreover, embodiments of the present invention further provide for spatial modulation may be used in connection with the exchange of other types of additional or alternative information.

### VIII. Conclusion

While various embodiments of the present invention have been described above, it should be understood that they have been presented by way of example only, and not in limitation. For instance, although examples have been described involving IEEE 802.15.3 and/or IEEE 802.15.3a communications, other short-range and longer-range communications technologies are within the scope of the present invention.

Also, the present invention is not limited to implementations involving only three frequency channels. Moreover, the techniques of the present invention may be used with signal transmission techniques other than OFDM and TFCs. Moreover, the present invention may be employed in simplex, half-duplex, and full-duplex communications, as the foregoing description provides examples of devices having both transmission and reception capabilities.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method, comprising:
(a) generating a signal that conveys a first information sequence; and
(b) spatially modulating the signal to further convey a second information sequence.
(c) transmitting the signal to a remote device.

2. The method of claim 1, wherein step (a) comprises generating an ultra wideband (UWB) signal.

3. The method of claim 1, wherein step (a) comprises modulating the first information sequence according to one of an orthogonal frequency division multiplexing (OFDM) modulation technique, and a direct sequence spread spectrum (DSSS) modulation technique.

4. The method of claim 1, wherein step (c) comprises:
transmitting the signal from two or more spatial locations based on the second information sequence.

5. The method of claim 1, further comprising:
(d) engaging in an initialization process with the remote device.

6. The method of claim 5, wherein step (d) comprises transmitting a predetermined spatially modulated symbol sequence to the remote device.

7. The method of claim 1, wherein the first information sequence is encrypted, and the second information sequence provides information for decrypting the first information sequence.

8. A method, comprising:
(a) receiving a wireless signal from a remote device,
(b) obtaining a first information sequence from the wireless signal through a first demodulation technique; and
(c) obtaining a second information sequence from the wireless signal through a second demodulation technique, wherein the second demodulation technique is a spatial demodulation technique.

9. The method of claim 8, wherein the first demodulation technique is one of an orthogonal frequency division multiplexing (OFDM) demodulation technique, and a direct sequence spread spectrum (DSSS) demodulation technique.

10. The method of claim 8, wherein the first information sequence is encrypted, and the second information sequence provides information for decrypting the first information sequence.

11. The method of claim 8, further comprising:
receiving an initialization communication from the remote device; and
establishing from the initialization communication a spatial frame of reference with respect to the remote device.

12. The method of claim 11, wherein the initialization communication includes a predetermined preamble.

13. The method of claim 8, wherein the wireless signals is an ultra wideband (UWB) signal.

14. An apparatus, comprising:
a first antenna at a first location;
a second antenna at a second location;
a first modulator configured to generate a signal that conveys a first information sequence
a second modulator configured to spatially modulate the signal to further convey a second information sequence, wherein the second modulator directs the signal to the first antenna when the second information sequence has a first value and directs the signal to the second antenna when the second information sequence has a second value.

15. The apparatus of claim 14, wherein the first modulator is configured to modulate the first information sequence according to one of an orthogonal frequency division multiplexing (OFDM) modulation technique, and a direct sequence spread spectrum (DSSS) modulation technique.

16. The apparatus of claim 14, further comprising a controller configured to provide the first and second information sequences to the first and second modulators, respectively.

17. The apparatus of claim 14, wherein the signal is an ultra wideband (UWB) signal.

18. The apparatus of claim 14, wherein the first information sequence is encrypted, and the second information sequence provides information for decrypting the first information sequence.

19. An apparatus, comprising:
a plurality of antennas;
a first demodulator configured to obtain through spatial demodulation a first information sequence from a plurality of signals received from the plurality of antennas; and to generate a representative signal of the plurality of signals;
a second demodulator configured to obtain a second information sequence from the representative signal.

20. The apparatus of claim 19, wherein the second demodulator employs one of an orthogonal frequency division multiplexing (OFDM) demodulation technique and a direct sequence spread spectrum (DSSS) demodulation technique to obtain the second information sequence.

21. The apparatus of claim 19, wherein the first information sequence is encrypted, and the second information sequence provides information for decrypting the first information sequence.

22. A computer program product comprising a computer useable medium having computer program logic recorded thereon for enabling a processor in a computer system to control a wireless communications device, the computer program logic comprising:
program code for enabling the wireless communications device to generate a signal that conveys a first information sequence;
program code for enabling the wireless communications device to spatially modulate the signal to further convey a second information sequence; and
program code for enabling the wireless communications device to transmit the signal to a remote device.

23. A computer program product comprising a computer useable medium having computer program logic recorded thereon for enabling a processor in a computer system to control a wireless communications device, the computer program logic comprising:
program code for enabling the wireless communications device to receive a wireless signal;
program code for enabling the wireless communications device to obtain a first information sequence from the wireless signal through a first demodulation technique; and
program code for enabling the wireless communications device to obtain a second information sequence from the wireless signal through a second demodulation technique, wherein the second demodulation technique is a spatial demodulation technique.
